(19) United States
(12) Patent Application Publication
(10) Pub. No.: US 2026/0003535 A1
(43) Pub. Date: Jan. 1, 2026

(54) FEEDBACK SIGNALLING

(71) Applicant: Arm Limited, Cambridge (GB)

(72) Inventors: Michael Andrew CAMPBELL, Cambridge (GB); Mark UNDERWOOD, Cambridge (GB)

(21) Appl. No.: 18/758,132

(22) Filed: Jun. 28, 2024

(51) Int. Cl. G06F 9/30; G06F 9/38; G06F 12/123

(52) U.S. Cl. CPC G06F 3/0653; G06F 3/061; G06F 3/0673; G06F 12/0862; G06F 3/0658

(57) ABSTRACT

An apparatus includes memory control circuitry to control access to at least one array of memory storage cells and to schedule received memory access requests targeting locations in the at least one array of memory storage cells. The apparatus also includes utilisation status determining circuitry to determine a utilisation status associated with accessing the array of memory storage cells, in which the utilisation status is indicative of a utilisation of a group of memory storage cells in the at least one array of memory storage cells. The apparatus includes feedback signalling circuitry to signal to a source of the received memory access requests feedback indicative of the determined utilisation status.

### TECHNICAL FIELD

The present technique relates to the field of data processing.

### Technical Background

Access to memory, such as to one or more arrays of memory storage cells, can be controlled by memory control circuitry (e.g. a memory controller). The memory control circuitry can also schedule memory access requests that are received and that target locations in the memory for which the memory control circuitry controls access.

### SUMMARY

At least some examples of the present technique provide an apparatus comprising: memory control circuitry to control access to at least one array of memory storage cells and to schedule received memory access requests targeting locations in the at least one array of memory storage cells;

utilisation status determining circuitry to determine a utilisation status associated with accessing the at least one array of memory storage cells; and feedback signalling circuitry to signal to a source of the received memory access requests feedback indicative of the determined utilisation status;

in which the utilisation status is indicative of a utilisation of a group of memory storage cells in the at least one array of memory storage cells;

At least some examples of the present technique provide an apparatus comprising: feedback receiving circuitry to receive feedback indicative of a utilisation status associated with accessing an array of memory storage cells; and speculative cache writeback circuitry to determine whether to generate a speculative cache writeback request based on the received feedback indicative of the utilisation status associated with accessing the array of memory storage cells.

At least some examples of the present technique provide a system comprising: either or both of the apparatuses described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of either or both of the apparatuses described above.

At least some examples of the present technique provide a system comprising the apparatuses described above.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing system having circuitry as described herein;

FIG. 2a illustrates an example apparatus including memory control circuitry, utilisation status determining circuitry, and feedback signalling circuitry;

FIG. 2b illustrates an example apparatus including feedback receiving circuitry and opportunistic memory access request generation circuitry;

FIG. 3a illustrates an example array of memory storage cells as described herein;

FIG. 3b illustrates an example rank of the array of memory storage cells of FIG. 3a;

FIG. 4 illustrates steps performed by a memory controller and memory request initiator as described herein;

FIG. 5 illustrates steps performed by a memory controller and memory request initiator as described herein;

FIG. 6 illustrates steps performed by a memory controller and memory request initiator as described herein;

FIG. 7 illustrates steps performed by a memory controller and memory request initiator as described herein; and

FIG. 8 illustrates a system and a chip-containing product.

### DESCRIPTION OF EXAMPLES

An apparatus may include memory control circuitry to control access to at least one array of memory storage cells and to schedule received memory access requests targeting locations in the at least one array of memory storage cells. The memory control circuitry may receive various memory access requests. For example, the received memory access requests may include demand memory access requests, such as demand load and store requests which are load and store requests issued in response to executed load and store instructions. However, the received memory access requests may also include other memory access requests which are not currently demanded by a memory request initiator but are issued in an opportunistic manner and that are predicted to be required in future. Such opportunistic memory access requests may include speculative cache writeback requests and prefetch requests, for example, and may be issued by a memory request initiator.

The present inventors have identified that a group of memory storage cells may at a given time have a certain level of utilisation (or busyness). For example, at a given time, the group of memory cells of the at least one array of memory storage cells may be fully or highly utilised. On the other hand, at a different time, the group of memory storage cells may not be fully or highly utilised. At times such as these, it would be advantageous to be able to signal the utilisation to a source of received memory access requests. Further, the memory storage cells may have different levels of utilisation across the at least one array of memory storage cells.

The present inventors have devised a feedback signalling approach whereby a utilisation status associated with accessing at least one array of memory storage cells and indicative of a group of memory storage cells in the at least one array of memory storage cells can be signalled to a source of memory access requests. The source of memory access requests can therefore act in dependence on the signalled feedback and take action in response and based on the feedback indicative of the utilisation status. This may include generating opportunistic memory access requests or suppressing generation of opportunistic memory access requests based on the feedback, for example. Hence, the present feedback signalling approach reduces the likelihood that opportunistic memory access requests will be generated and issued when they are not able to be processed, thereby reducing processing time and memory bandwidth that would otherwise have been used to generate and issue unnecessary opportunistic memory access requests. Further, the present approach increases the likelihood that opportunistic memory access requests are generated and issued when they are able to be processed.

Thus, in some examples discussed below, utilisation status determining circuitry is provided to determine a utilisation status associated with accessing the at least one array of memory storage cells and feedback signalling circuitry is provided to signal to a source of the received memory access requests feedback indicative of the determined utilisation status, where the utilisation status is indicative of a utilisation of a group of memory storage cells in the least one array of memory storage cells. Accordingly, the apparatus comprising the utilisation status determining circuitry and the feedback signalling circuitry is able to provide feedback to initiators of memory requests that indicates a utilisation status associated with accessing the at least one array of memory storage cells. As such, this approach enables the recipients of the feedback to take appropriate action based on the signalled feedback, such as the issuing of or the suppression of issuing opportunistic memory access requests. Thus, an improved utilisation feedback signalling approach is supported that reduces the likelihood that memory control circuitry is to receive an opportunistic memory access request that the memory control circuitry is unable to process, or that the memory control circuitry processes at the expense of a non-opportunistic memory access request. As such, delays associated with memory control circuitry processing opportunistic memory access requests instead of demand memory access requests can be reduced, thereby reducing the length of time to return data for demand memory access requests and reducing the likelihood that the processing pipeline has to be stalled.

Indeed, in some examples discussed below, the utilisation status is indicative of a utilisation of a group of memory storage cells in the at least one array of memory storage cells. The group of memory storage cells may be one of a channel, a rank, a group of banks, a bank, and a row cells in the at least one array of memory storage cells. By using a utilisation status that is indicative of a utilisation of a group of memory storage cells, the feedback signalled to the source of the memory access requests also indicates this utilisation status. Hence, the utilisation of a specific group of memory storage cells can be signalled. Further, a granularity of information regarding the utilisation can be increased, thereby enabling the source of the memory access requests to take action specific to the group of memory storage cells, for example by targeting or not targeting the group of memory storage cells with opportunistic memory access requests. Accordingly, the generated opportunistic memory access request can issue opportunistic memory access requests that target the least utilised memory storage cells and in some examples delay issuing of opportunistic memory access requests that do not. Further, the impact caused by opportunistic memory access requests can be spread between groups of memory storage cells and underutilised groups can be specifically targeted, thereby reducing the impact of the opportunistic memory access requests on the highly utilised groups and reducing a delay in performing the opportunistic memory access request.

Utilisation of a group of memory storage cells may be indicative of a number of memory access requests targeting the group of memory storage cells. For example, the utilisation of the group of memory storage cells may correspond to a number of demand memory access requests targeting the given group of memory storage cells or a proportion of the total number of groups of memory storage cells which are targeted by demand memory access requests. For example, in a DRAM implementation, there may be N bank groups and concurrent requests to all bank groups may be supported (to allow for latency reduction). In this example, demand memory access requests may be received that target M of the N bank groups (where M is less than N), thereby leaving N - M bank groups idle. As discussed herein, by determining a utilisation status indicative of a utilisation of a group of memory storage cells (i.e. the idle bank group(s)), an opportunistic memory access request (such as a speculative cache writeback) can be generated targeting the idle bank group(s).

Further, in the event that there is capacity within the scheduling of memory access requests to a row which demand memory access requests are already targeting, in-row hits can be increased. For example, an opportunistic memory access request could be generated targeting this row which demand memory access requests are already targeting and which has scheduling capacity.

In some examples, the utilisation status is indicative of a utilisation of a group of memory storage cells in the at least one array of memory storage cells, in which the group of memory storage cells is smaller than the entire at least one array of memory storage cells. Hence, the group of storage cells may correspond to a subset of memory storage cells of the memory storage cells that make up the at least one array of memory storage cells.

In some examples, the at least one array of memory storage cells comprises DRAM (dynamic random access memory) storage. As such, the memory control circuitry controls access to an array of DRAM storage cells. In some cases, the memory control circuitry may comprise a DRAM memory controller. As readout of data from capacitive DRAM storage cells is destructive, reading or writing DRAM storage requires a row of cells including the cell of interest to be activated by loading the charges stored in that row of cells to a row buffer before reads and writes can be performed on that row. On completion of any reads or writes in the row buffer, the data for that row can be written back to the DRAM storage cells. As a result of this, it can be more time-efficient to schedule memory access requests that target data in the same row such that all memory access requests are performed while the data is copied in a row buffer, as there is a time and energy penalty associated with re-loading data into a row buffer and writing back data from the row buffer to the DRAM storage cells. Because of this, capacity or utilisation of the memory control circuitry, which schedules received memory access requests, can have a significant impact on data access times. Hence, the present approach can be particularly advantageous for DRAM implementations which are reliant on the performance of the memory control circuitry to schedule memory access requests.

Further, as discussed herein, opportunistic memory access requests (i.e. prefetch requests and/or speculative cache writebacks) are particularly beneficial in a DRAM implementation. Because of the penalties associated with accessing rows in a DRAM implementation, it is beneficial if the memory control circuitry receives opportunistic memory access requests (when the memory control circuitry is able to process them), because the memory control circuitry is then able to schedule and coordinate the opportunistic memory access request along with other memory accesses to that same row, thereby performing memory accesses to the same row while that row is activated and increasing the DRAM power efficiency by not having to incur the power and time costs associated with deactivating a row and activating a different row. However, if a memory access request is only received when it is actually required (i.e. it hasn’t been issued opportunistically), the memory control circuitry has less flexibility over scheduling the request and coordinating the request with other access requests targeting the same row. For example, the memory control circuitry may be required to deactivate a row and activate a different row just to fulfil the demand access request that is required at that time. If an opportunistic memory access request had been issued instead the memory control circuity would have been able to coordinate access to the relevant row with other memory accesses to reduce the time and power penalties associated with row access. Accordingly, by providing a mechanism that increases the likelihood that opportunistic memory access requests are successfully performed, access time and power required to access data in the DRAM storage can also be reduced. Further, by providing a mechanism that reduces the likelihood that opportunistic memory access requests are generated and issued when they are not able to be processed, processing time and memory bandwidth associated with generating and issuing the unnecessary opportunistic memory access requests can be preserved.

In some examples, the feedback is indicative of whether the memory control circuitry has capacity to process opportunistic memory access requests, the opportunistic memory access requests being memory access requests not currently demanded by a memory access request initiator but predicted to be required in future. Hence, as described herein, the apparatus is able to signal feedback that indicates whether the memory control circuitry is able to process opportunistic memory access requests. This enables a memory request initiator to take action, or not take action, (such as the issuing or not issuing of opportunistic memory access requests) based on the feedback, rather than issuing opportunistic memory access requests without any knowledge of whether the memory control circuitry is going to be able to process the opportunistic memory access request. Accordingly, the likelihood that an unnecessary (because it could not be processed) opportunistic memory access request is generated and issued to the memory control circuitry is reduced, thereby preventing processing resources and memory bandwidth from being used unnecessarily.

In some examples, the opportunistic memory access requests comprise one or more of:

speculative cache writebacks; and/or prefetch requests. Speculative cache writebacks may be cache writebacks performed at times other than cache line eviction, for example, to pre-empt a time at which they are required. Similarly, prefetch requests may be performed to prefetch data into a cache ahead of a time when that data is needed for a demand memory access request. Hence, while advantageous, the opportunistic memory access requests are memory access requests that are issued opportunistically or optionally in the sense that they are not currently demanded by a memory access request but they are predicted to be required in the future, and doing so would be beneficial if they are able to be processed. Hence, the present disclosure draws a distinction between opportunistic memory access which are memory access requests that are not currently demanded by a memory request initiator but are predicted to be required in the future and memory access requests that are currently demanded by a memory request initiator (such as a demand memory access request, such as a demand load or store). The present techniques allow for opportunistic memory access requests to be performed if there is capacity to do so, and not performed at the expense of demand memory access requests.

In some examples, the group of memory storage cells in the at least one array of memory storage cells corresponds to one of a channel, a rank, a group of banks, a bank, and a row cells in the at least one array of memory storage cells. Thus, it will be appreciated that the group of memory storage cells refers to a group of memory storage cells corresponding to a variety of different level of granularity and hierarchy within the at least one array of memory storage cells.

In some examples, the utilisation status is indicative of a utilisation of the memory control circuitry. As discussed above, the memory control circuitry schedules received memory access requests that target locations in the at least one array of memory storage cells. Thus, the memory control circuitry itself may be highly utilised as a result of a large number of memory access requests having been received and that require processing and scheduling. As used herein, utilisation corresponds to a busyness.

The utilisation status may correspond to or be indicative of a number of entries in a queue associated with the memory control circuitry that are in use. For example, as memory access requests are received by the memory control circuitry, the pending memory access requests may be queued while the memory control circuitry processes each memory access request. The utilisation status determining circuitry may therefore determine the utilisation status based on the number of entries of a queue of pending memory access requests that are in use. One or more predetermined thresholds may be used to determine whether the number of queue entries indicates that the memory control circuitry is to be considered highly utilised.

Hence, the feedback signalled to a source of the received memory access request is indicative of a utilisation of the memory control circuitry. The utilisation status is not particularly limited and may include a number of utilisation states such as highly utilised, moderately utilised, lowly utilised, busy, not busy, etc. In some examples, the utilisation status may include a percentage utilisation or the like. In some examples, the feedback is a single bit flag to indicate the utilisation status, or a multi-bit flag to indicate a state of a plurality of utilisation states.

Further, it will be appreciated that a utilisation of the memory control circuitry can change over time and so the utilisation status may correspond to an average utilisation over a period of time. For example, the utilisation status may correspond to or be indicative of a number of entries a queue of pending memory access requests that are in use and that the memory control circuitry is to process over a predetermined time period.

In some examples, the utilisation status is indicative of an ability of the memory control circuitry to schedule received memory access requests. Hence, the memory control circuitry may be considered to be highly or fully utilised if the memory control circuitry is not able to schedule additional memory access requests. In some examples, the feedback is a single bit flag to indicate whether the memory control circuitry is able to schedule additional memory access requests. Again, the utilisation status may be determined based on the number of entries of a queue of pending memory access requests that the memory control circuitry is to process or schedule.

In some examples, the feedback comprises information identifying a most or least utilised group of memory storage cells. Thus, greater detail regarding the utilisation of the at least one array of memory storage cells can be provided to memory request initiators. Indeed, identifying a most or least utilised group of memory storage cells enables the memory request initiator to target or avoid specific groups of memory storage cells with the opportunistic memory access requests, thereby helping the memory control circuitry load balance opportunistic memory access requests between the memory storage cells.

In some examples, the memory control circuitry is configured to: determine that a received memory access request is an opportunistic memory access request based on an encoding associated with the received memory access request indicating that the received memory access request may be ignored, and determine, based on the utilisation status, whether the opportunistic memory access request is to be ignored. Hence, opportunistic memory access requests may be differentiated from non-opportunistic memory access requests by an encoding indicating that the memory access request may be ignored. Such an encoding indicates that the memory access request is a ‘droppable’ opportunistic memory access request which is to be performed depending on the utilisation status, for example only if the utilisation status indicates that the opportunistic memory access request is able to be performed or currently being accepted. This functionality enables the memory control circuitry to determine whether to perform the opportunistic memory access request based on the utilisation status. This functionality also enables a memory access request initiator to issue opportunistic memory access requests that can be identified as such by the memory control circuitry. Hence, the memory control circuitry is able to identify opportunistic memory access requests and drop or ignore opportunistic memory access requests depending on utilisation. This can reduce the likelihood that demand memory access requests (i.e. non-opportunistic memory access requests) are delayed as a result of processing opportunistic memory access requests instead.

In some examples, the feedback signalling circuity is configured to signal the feedback as part of a read/write response issued in response to receiving the opportunistic memory access request. Thus, in these examples, a signalling mechanism that may already exist for the memory control circuitry to provide a read/write response issued in response to received memory access requests can be used to also signal the feedback. Use of the read/write response can allow the feedback signalling circuitry to signal feedback without requiring a further, for example dedicated, communication pathway, and thus without additional on-chip circuitry.

In some examples, the feedback indicates that the opportunistic memory access request has been ignored. Thus, in these examples, the source of the received memory access requests can receive feedback indicating that opportunistic memory access requests has been ignored and determine to take action or not take action based on this. For example, the source of the received memory access requests can determine whether to issue further opportunistic memory access requests based on the feedback. In some examples, the source of the received memory access requests may suppress generation of further opportunistic memory access requests based on the feedback indicating that a previous opportunistic memory access request has been ignored. As a result, the likelihood that unnecessary opportunistic memory access requests are generated and then processed by the memory control circuitry when the memory control circuitry is likely to ignore the opportunistic memory access request is reduced, thereby saving processing resources and memory bandwidth that would have been used to generate and process the unnecessary opportunistic memory access request.

In some examples, the feedback signalling circuitry is configured to signal the feedback using an indication separate from a read/write response. In some examples, the indication may be a dedicated indication or dedicated signalling pathway. As a result, the feedback may be signalled without being signalled in response to an opportunistic memory access request, and thus the feedback signalling circuitry can pro-actively signal feedback without waiting to receive a memory access request.

As described above, an apparatus is provided with memory control circuitry, utilisation status determining circuitry, and feedback signalling circuitry. In at least some of the examples that follow there is described an apparatus with feedback receiving circuitry and speculative cache writeback circuitry. In this way, in some examples, these apparatuses may be considered as a sender-receiver pair, where feedback signalled from feedback signalling circuitry of the first apparatus is received by the feedback receiving circuitry of the second apparatus. In some examples, these apparatuses form a system.

Hence, in some examples, there is provided an apparatus comprising feedback receiving circuitry to receive feedback indicative of a utilisation status associated with accessing an array of memory storage cells. This apparatus may, for example, correspond to the source of the memory requests received by the feedback signalling circuitry. This apparatus further comprises speculative cache writeback circuitry to determine whether to generate a speculative cache writeback request based on the received feedback indicative of the utilisation status associated with accessing the array of memory storage cells.

As such, generation of speculative cache writeback requests is dependent on the received feedback indicative of a utilisation status associated with accessing an array of memory storage cells. As discussed herein, this reduces the likelihood that a speculative cache writeback request will be generated when accessing the array of memory storage cells may not be possible or undesirable in view of a given level of utilisation. Accordingly, processing time and memory bandwidth associated with generating and issuing the speculative cache writeback request when it cannot then be handled is preserved.

In some examples, the at least one array of memory storage cells comprises DRAM storage. As discussed above, capacity or utilisation of the memory control circuitry in a DRAM implementation can have a significant impact on data access times. Hence, the present approach can be particularly advantageous for DRAM implementations which are reliant on the performance of the memory control circuitry to schedule memory access requests. Further, opportunistic memory access requests can be particularly beneficial for DRAM implementations as they increase the likelihood of an in-row hit, thereby increasing DRAM power efficiency, and so it would be advantageous to increase the likelihood that opportunistic memory access requests are generated when they are able to be processed by memory control circuitry.

In some examples, the speculative cache writeback circuitry is configured to determine that the speculative cache writeback request is not to be generated based on determining that the feedback indicates that memory control circuitry controlling access to the array of memory storage cells does not have capacity to process opportunistic memory access requests. Thus, in cases where the memory control circuitry does not have capacity to process speculative cache writeback requests, a memory access request initiator is informed as such and is then able to suppress generation of the speculative cache writeback requests. As discussed herein, this avoids expending processing resources and memory bandwidth on generating and issuing a speculative cache writeback request when the speculative cache writeback request is not able to be performed.

In some examples, the speculative cache writeback circuitry is configured to determine that the speculative cache writeback request is to be generated based on determining that the feedback indicates that memory control circuitry controlling access to the array of memory storage cells has capacity to process speculative cache writeback requests.

Thus, action of a memory request initiator can be responsive to the signalled feedback and thus the ability of the memory control circuitry to process speculative cache writeback requests. As discussed herein, this reduces processing time and memory bandwidth used for generating and issuing speculative cache writeback requests that will not be processed by the memory control circuitry, and increases the likelihood that a speculative cache writeback request is generated and issued that can be processed by memory control circuitry.

In some examples, the feedback comprises information indicative of a utilisation of a group of memory storage cells in the array of memory storage cells. The group of memory storage cells may be a rank or a bank of memory storage cells, for example a rank or bank of DRAM storage cells. In some examples, the group of memory storage cells corresponds to one of: a channel; a rank; a group of banks; a bank; and a row of cells in the at least one array of memory storage cells. By using information indicative of a utilisation of a group of memory storage cells, the feedback receiving circuitry receives more granular information about the utilisation of the memory storage cells, allowing a more informed decision to be made regarding whether to generate opportunistic memory access requests.

In some examples, the feedback comprises information identifying a least or most utilised group of memory storage cells. The information can be a group identifier of the group of memory storage cells, or an address or range of addresses that correspond to the group of memory storage cells. Again, the group of memory storage cells may be one of a number of granularities of cells of the array of memory storage cells, for example a rank or a bank of memory storage cells (such as a rank or bank of DRAM storage cells). As a result, the feedback receiving circuitry and the information and can use this information to take action based on specific groups of memory storage cells.

In some examples, the speculative cache writeback circuitry is configured to generate a speculative cache writeback request targeting a location in the array of memory storage cells based on the feedback. Thus, the speculative cache writeback circuitry can use the feedback to target specific locations (such as specific groups, ranks, and/or banks) of memory storage cells with a speculative cache writeback request.

In some examples, the feedback comprises information identifying a least utilised group of memory cells, and the speculative cache writeback circuitry is configured to generate a speculative cache writeback request targeting a location in the array of memory storage cells corresponding to the least utilised group of memory cells. Accordingly, the speculative cache writeback circuitry can issue speculative cache writeback requests that target the least utilised memory storage cells and in some examples delay issuing of speculative cache writeback requests that do not. Further, the speculative cache writeback circuitry can ‘load balance’ the speculative cache writeback requests across the array of memory storage cells and reduce the likelihood that a location in the memory storage cell is targeted that corresponds to a highly utilised memory storage cell.

In some examples, the feedback comprises information identifying a most utilised group of memory cells, and the speculative cache writeback circuitry is configured to suppress generation of a speculative cache writeback request targeting a location in the array of memory storage cells corresponding to the most utilised group of memory cells. Accordingly, the speculative cache writeback requests targeting the most utilised memory storage cells can be suppressed such that speculative cache writeback requests do not target these highly utilised memory storage cells, reducing the demand placed on already highly utilised memory storage cells.

In some examples, the speculative cache writeback request has an encoding indicating that the speculative cache writeback request may be ignored by memory control circuitry controlling access to the array of memory storage cells. This functionality enables a memory access request initiator to issue speculative cache writeback requests that can be identified as such by memory control circuitry receiving the memory access requests. This can reduce the likelihood that demand memory access requests (i.e. non-opportunistic memory access requests) are delayed as a result of processing speculative cache writeback requests instead. This also provides an efficient mechanism for the opportunistic memory access request generation circuitry to issue memory access requests that are identifiable as opportunistic memory access requests (i.e. a speculative cache writeback request), the performance of which is optional and depends on utilisation associated with accessing one or more locations in the memory storage array.

In some examples, the feedback receiving circuity is configured to receive the feedback as part of a read/write response received in response to a given speculative cache writeback request issued by the speculative cache writeback circuitry to memory control circuitry. As discussed above, in these examples, a signalling mechanism that may already exist for the memory control circuitry to provide a read/write response issued in response to received memory access requests can be used to also signal the feedback to the feedback receiving circuitry. Use of the read/write response can allow the feedback receiving circuitry to receive signalled feedback without requiring a further, for example dedicated, communication pathway, and thus without additional on-chip circuitry.

In some examples, the feedback receiving circuitry is configured to receive the feedback via an indication separate from a read/write response. As a result, the feedback may be received by the feedback receiving circuitry without being received in response to a speculative cache writeback request, and thus the feedback receiving circuitry can pro-actively receive feedback without having to issue a memory access request.

In some examples, the speculative cache writeback circuitry is system cache control circuitry to control issuing of the speculative cache writeback request to the memory control circuitry.

### Specific examples will now be described with reference to the drawings.

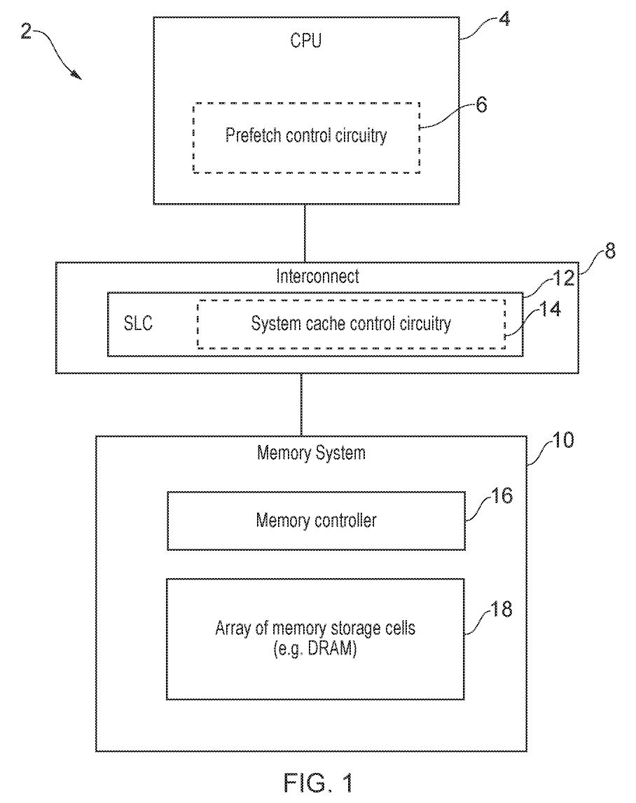

FIG. 1 illustrates an example data processing system 2 in which the present techniques may be performed. As shown, data processing system 2 includes a central processing unit (CPU) 4 for performing general purpose processing. CPU 4 may include one or more caches (not shown), for example level one caches and level two caches. However, it will be appreciated that CPU 4 is an example of a requester device and that other requester devices may be present, such as graphical processing units, network interface controllers, or display controllers for controlling display of data on a screen for example. It will also be appreciated that while only one CPU 4 is shown, additional CPUs and/or other memory request initiators may be provided.

Data processing system 2 also includes an interconnect 8 for maintaining cache coherency between the CPU 4 and other requester devices (not shown). Interconnect 8 may support a coherency protocol which defines a set of cache coherency states, transaction types, and rules for processing each transaction type, to control access to the memory system 10. A system level cache (SLC) 12 is coupled to the interconnect 8 but not assigned to a particular requester device. The SLC 12 may, for example, be provided to speed up access to data by uncached requesters (not shown), allowing faster access than if all reads and writes from the uncached requester have to be served by the memory system 10.

As shown, memory system 10 includes memory controller 16 (which may include memory control circuitry), which is responsible for controlling access to an array of memory storage cells 18 and scheduling received memory access requests targeting locations in the array of memory storage cells 18. The array of memory storage cells may comprise DRAM storage cells, for example. In a DRAM implementation, memory controller 16 may correspond to a DRAM memory controller.

Memory controller 16 may receive demand memory access requests issued by requester devices (such as CPU 4), and also opportunistic memory access requests. As described herein, opportunistic memory access requests are memory access requests not currently demanded by a memory access request initiator (such as a requester device) but predicted to be required in future. Such opportunistic memory access requests may comprise prefetch requests and/or speculative cache writebacks.

As shown, CPU 4 can in some examples include prefetch control circuitry 6 for controlling issuing of prefetch requests to prefetch data from the memory system 10. Prefetch requests may be generated based on a prediction of addresses which may be required in the future by demand memory access requests generated by processing circuitry in response to execution of load/store instructions. In this way, pipeline stalls caused by instructions waiting for data to be returned from memory can be reduced or avoided. Such prefetch requests can be received by the memory controller 16 and processed to return the requested data.

As also shown, SLC 12 can in some examples include system cache control circuitry 14 for controlling issuing of speculative cache writeback requests to the memory system 10. As data is written to the SLC 12, at some point that data may be required to be written back to the memory system 10 (a cache writeback). One way to do this is to postpone the cache writeback until the data written to the cache is about to be replaced by other data being written to the cache (i.e. on cache line eviction). However, in some cases, it can be advantageous to perform speculative cache writebacks, i.e. a cache writeback of data that isn’t triggered by the data being replaced in the cache. For example, in a DRAM implementation, this can increase power efficiency of the memory storage system by increasing in-row hits. Such speculative cache writeback requests can be received and processed by the memory controller 16.

Thus, it will be appreciated that a source of memory access requests received by the memory controller 16 can include the prefetch control circuitry 6 (i.e. the CPU 4) and/or the system cache control circuitry 14 (i.e. the SLC 12).

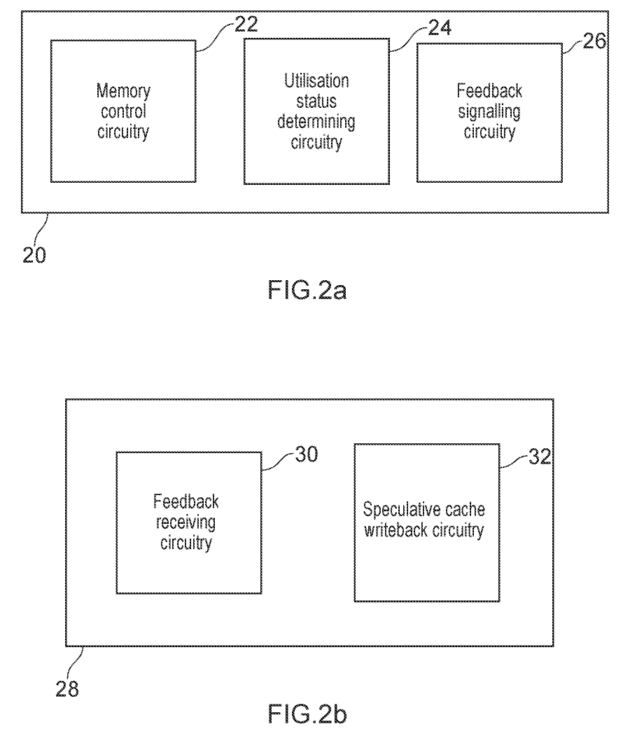

FIG. 2a illustrates an example apparatus 20 including memory control circuitry 22, utilisation status determining circuitry 24, and feedback signalling circuitry 26. Apparatus 20 may correspond to memory controller 16 of FIG. 1. Memory control circuitry 22 controls access to at least one array of memory storage cells (such as the array of memory storage cells 18 of FIG. 1) and schedules received memory access requests targeting locations in the at least one array of memory storage cells.

As discussed herein, the present inventors have devised a feedback signalling approach whereby utilisation associated with accessing at least one array or memory storage cells can be signalled to a source of memory access requests. The source of the memory access requests can thus act in dependence on the signalled feedback. Thus, utilisation status determining circuitry 24 determines a utilisation status associated with accessing the array of memory storage cells where the utilisation status is indicative of a utilisation of a group of memory storage cells in the at least one array of memory storage cells, and feedback signalling circuitry 26 signals to a source of the received memory access requests feedback indicative of the determined utilisation status. It will be appreciated that the source of the received memory access requests that is signalled by the feedback signalling circuitry 26 of apparatus 20 may correspond to CPU 4 (or another requester device not shown) or SLC 12 of FIG. 1.

FIG. 2b illustrates an example apparatus 28 including feedback receiving circuitry 30 and speculative cache writeback circuitry 32. Apparatus 28 may correspond to a source of the memory access requests received by the memory control circuitry 22 of apparatus 20 of FIG. 2a, for example. Thus, apparatus 28 may correspond to SLC 12 of FIG. 1. In some examples, apparatus 28 may include prefetch control circuitry instead of speculative cache writeback circuitry, and thus in these examples, apparatus 28 may correspond to CPU 4 (or another requester device not shown).

Feedback receiving circuitry 30 receives feedback indicative of a utilisation status associated with accessing an array of memory storage cells. For example, feedback receiving circuitry 30 may receive the feedback from the feedback signalling circuitry 26 of apparatus 20 of FIG. 2a. Speculative cache writeback circuitry 32 determines whether to generate a speculative cache writeback request based on the received feedback indicative of the utilisation status associated with accessing the array of memory storage cells.

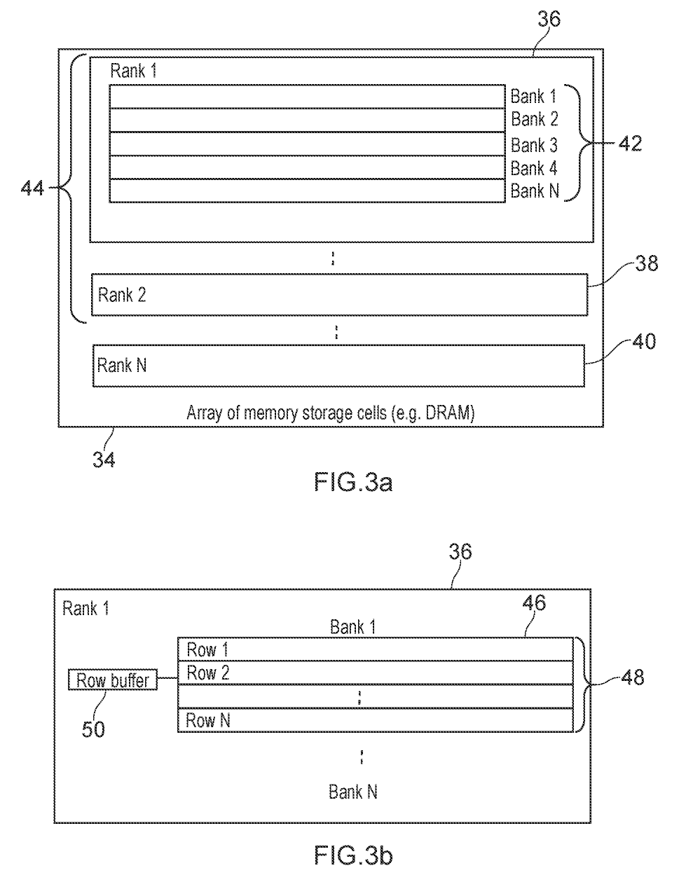

Thus, from one perspective, apparatus 20 of FIG. 2a and apparatus 28 of FIG. 2b act as a sender-receiver pair. Apparatus 20 signals the feedback to apparatus 28 and apparatus 28 determines whether to generate a speculative cache writeback request based on the feedback. As discussed above, in some examples, apparatus 20 may correspond to a memory controller, for example a DRAM memory controller, and apparatus 28 may correspond to a system level cache, for example. It will be appreciated that the signalling of feedback between the feedback signalling circuitry 26 (i.e. apparatus 20) and the feedback receiving circuitry 30 (i.e. apparatus 28) may be direct or indirect. For example, in some cases, the feedback may be signalled from the feedback signalling circuitry 26 to the feedback receiving circuitry 30 via intermediate circuitry or components and in other cases the feedback may be signalled directly from the feedback signalling circuitry 26 to the feedback receiving circuitry 30.FIG. 3a illustrates an example array of memory storage cells 34 as described herein, and in this example the array of memory storage cells 34 comprises DRAM storage cells, although it will be appreciated that the array of memory storage cells can take a variety of forms. The array of memory storage cells 34 may correspond to the array of memory storage cells 18 of FIG. 1.

As shown, the array of memory storage cells 34 includes N ranks, including rank 136, rank 2, 38, and rank N 40. In this example, rank 1 and rank 2 form a channel 44. It will be appreciated that other ranks may form other channels and that channel 44 is merely an example channel may be formed by a plurality of ranks.

Each rank may be provided with a separate enable signal, and the power state of each rank can be varied independently by a power controller (not shown). Each rank typically includes a plurality of physical chips (not shown) and these chips are arranged to provide a group of N banks 42 per rank.

FIG. 3b illustrates an example rank 36 (such as rank 136) of the array of memory storage cells 34 of FIG. 3a. Each bank comprises a plurality of rows 48. As shown, bank 146 includes N rows 48. It will be appreciated that N used across FIGS. 3a and 3b may refer to different numbers and does not necessarily imply that there are equal numbers of ranks, banks, and rows.

As shown in FIG. 3b, for each bank 46, there is provided a row buffer 50 for storing at least one row of data from the associated bank. It will be appreciated that each bank is provided with its own row buffer, so that it is possible to read/write to rows in different banks in parallel, but not possible to read/write to different rows in the same bank in parallel. In order to access a data value in a row, the row first has to be moved in to the relevant row buffer via a command from a memory controller or memory control circuitry. Once the row has been stored in its associated row buffer, individual memory accesses within that row can be performed.

Thus, as shown in FIGS. 3a and 3b, the array of memory storage cells 34 may include a plurality of levels or units of granularity of a memory storage array hierarchy. For example, the array of memory storage cells may be considered as including a plurality of channels, each channel comprising one or more ranks. The ranks may include a plurality of banks. The banks may be grouped into groups of banks. The banks may each include a plurality of rows, where each row is a row of cells of the array of memory storage cells. In this way, the group of memory storage cells in the array of memory storage cells may refer to any of the different units of granularity or levels in the memory storage cell array hierarchy. Accordingly, the group of memory storage cells in the array of memory storage cells may refer to a channel, a rank, a group of banks, a bank, and/or a row of cells.

As discussed herein, DRAM storage has a non-uniform access timing requirement, which means that once a row has been activated for access, it is beneficial to perform further pending access requests to that row before that row is deactivated and another row activated for access. Memory control circuitry (such as memory control circuitry 22 of FIG. 2a or memory controller 16 of FIG. 1) thus schedules memory access requests accordingly.

Hence, capacity or utilisation of the memory control circuitry, which schedules received memory access requests, can have a significant impact on data access times. Indeed, at a given time, the memory controller may be highly utilised and/or unable to process further memory access requests. At times such as these, it would be beneficial to provide a mechanism by which the utilisation could be determined and signalled to devices that send memory access requests to the memory controller, such that the devices can take action based on the utilisation. Equally, at other times, the memory controller may not be highly utilised and thus able to process memory access requests and so it would be beneficial to provide a mechanism by which this could be signalled to devices that generate opportunistic memory access requests, so that they can take action based on this.

Further, in a DRAM implementation, opportunistic memory access requests (i.e. prefetch requests and/or speculative cache writebacks) can be particularly beneficial. This is because the opportunistic memory access requests are issued before they are actually required. In the example of a prefetch request, this request prefetches data into a cache before it is required by an executing instruction. Because of the penalties associated with accessing rows in a DRAM implementation, it is beneficial if the memory control circuitry receives the prefetch request and is then able to schedule the prefetch request along with other memory accesses to that same row. However, if a prefetch request is not received and instead a demand access request is received at the time the data is actually required, the memory control circuitry has less flexibility over scheduling the request and coordinating the request with other access requests targeting the same row. For example, the memory control circuitry may be required to deactivate a row and activate a different row just to fulfil the demand access request that was not covered by a prefetch request. If this data had been covered by a prefetch request in advance of a time when it was required, the memory control circuity would have been able to coordinate access to the relevant row with other memory accesses to reduce the time and power penalties associated with row access. Similarly, speculative cache writebacks are cache writebacks performed speculatively, i.e. not necessarily triggered by a cache line eviction. Such speculative cache writebacks can be scheduled and coordinated with other memory accesses that target the same row to reduce overall access time and power use. However, if cache writebacks are not performed speculatively, and are only performed at the point at which they are required (i.e. on cache line eviction), the memory control circuitry has less flexibility to schedule and coordinate the cache writeback with other memory accesses to the same row. Thus, opportunistic memory access requests help to increase the efficiency of the DRAM storage by reducing access time and the power required to access the data. Accordingly, by providing a mechanism that increases the likelihood that opportunistic memory access requests are successfully performed, access time and power required to access data in the DRAM storage can also be reduced. Further, by providing a mechanism that reduces the likelihood that opportunistic memory access requests are generated and issued when they are not able to be processed, processing time and memory bandwidth associated with generating and issuing the unnecessary opportunistic memory access requests can be preserved.

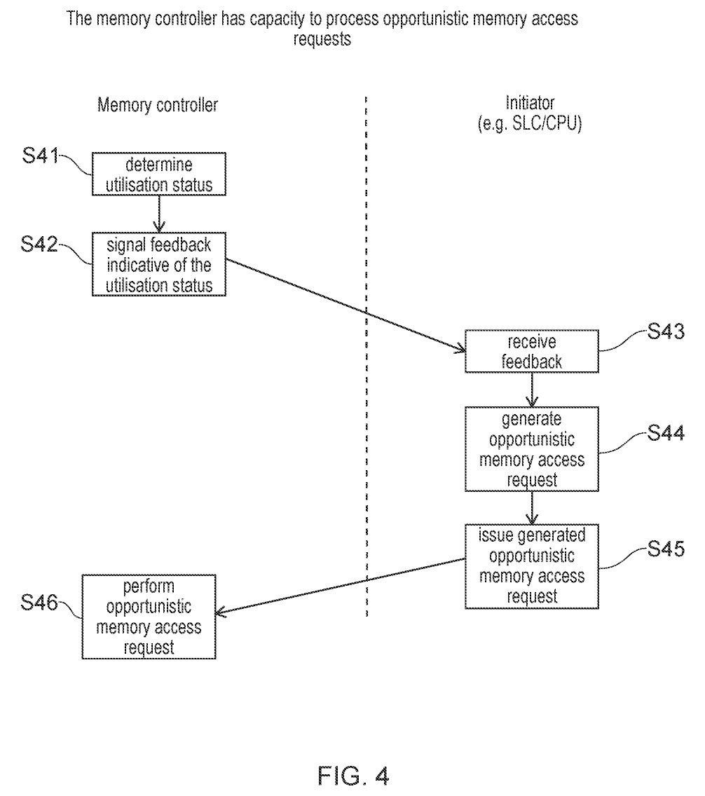

Example signalling between a memory controller and a memory request initiator (i.e. a source of memory requests that are received by the memory controller) according to the present techniques will now be described with reference to FIGS. 4 to 7. The memory controller of these figures may correspond to memory controller 16 of FIG. 1 or apparatus 20 of FIG. 2a. The initiator of these figures may correspond to CPU 4 or SLC 12 of FIG. 1 or apparatus 28 of FIG. 2b. For example, when the opportunistic memory access request is a speculative cache writeback, the initiator in FIGS. 4 to 7 may correspond to SLC 12 of FIG. 1 or apparatus 28 of FIG. 2b. As discussed herein, an opportunistic memory access request may comprise a prefetch request and/or a speculative cache writeback. While discussion of FIGS. 4 to 7 below refers to an opportunistic memory access request, it will be appreciated that this therefore refers to prefetch request and/or a speculative cache writeback.

Turning to FIG. 4, this figures shows example steps performed by a memory controller and memory request initiator when the memory controller has capacity to process opportunistic memory access requests. For example, this could be because the group of memory storage cells in the at least one array of memory storage cells is not fully utilised.

As shown, the memory controller determines a utilisation status (step S41). This utilisation status may be associated with accessing an array of memory storage cells for which the memory controller controls and schedules access. The utilisation status may be indicative of a utilisation of a group of memory storage cells in the at least one array of memory storage cells. For example, the utilisation status may be indicative of a utilisation of a specific group of memory storage cells in the at least one array of memory storage cells, such as a channel, rank, group of banks, bank, or row of cells. The utilisation status may be indicative of a utilisation of the memory controller itself. For example, the utilisation status may be indicative of an ability of the memory control circuitry to schedule received memory access requests. It will be appreciated that a capacity of the memory controller to process opportunistic memory access requests may refer to either or both the capacity of the memory controller itself, and the capacity of the underlying memory storage cells. As discussed above, the utilisation status may be determined based on the number of entries in a queue of pending memory access requests that are waiting to be processed and/or scheduled by the memory control circuity. Additionally, or alternatively, the utilisation status may be determined based on a utilisation of the memory storage cells, for example a proportion of cells containing data compared to a total number of cells or a number of cells containing data, etc.

In the example of FIG. 4, the utilisation status determined at S41 indicates that the memory controller has capacity to process opportunistic memory access requests. The memory controller signals feedback indicative of the utilisation status (S42). The feedback is signalled to initiator, where at S43, the feedback is received by the initiator. It will be appreciated that the feedback indicative of the utilisation status may take a variety of forms. For example, a single bit flag may be used to indicate whether the memory controller has capacity to process opportunistic memory access requests or not. In other examples, a multi-bit indicator may be used to provide a more granular indication of capacity.

At S44, the initiator generates an opportunistic memory access request. In examples, the initiator performs S44 based on the feedback received at S44 indicating that the memory controller has capacity to process opportunistic memory access requests. As discussed herein, such an opportunistic memory access request may include one or more of a prefetch request (for example when the initiator is a CPU) and/or a speculative cache writeback (for example when the initiator is a SLC). At S45, the initiator issues the generated opportunistic memory access request to the memory controller. At S46, the memory controller performs the opportunistic memory access request issued by the initiator at S45.

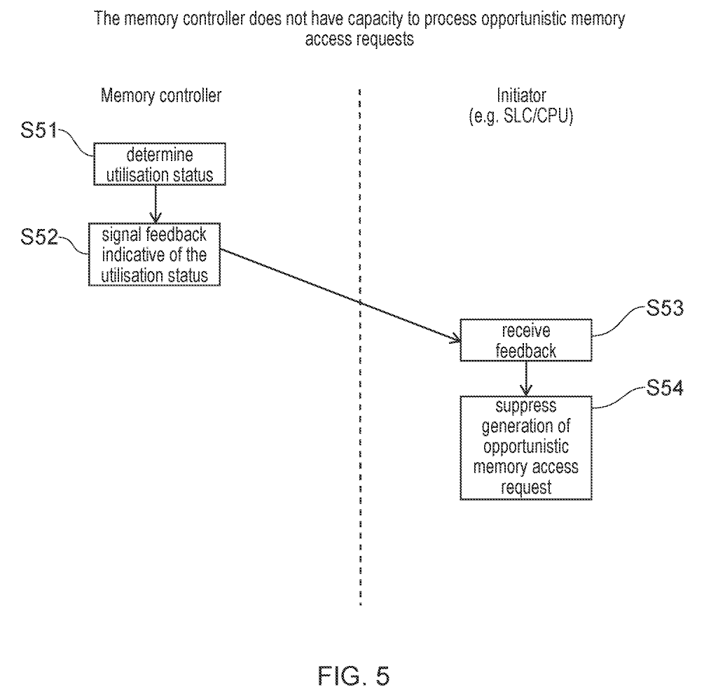

FIG. 5 shows a similar arrangement of memory controller and initiator as FIG. 4, but when the memory controller does not have capacity to process the opportunistic memory access requests. For example, this could be because the group of memory storage cells in the at least one array of memory storage cells is fully utilised or highly utilised.

Memory controller determines a utilisation status at S51. For example, as for S41, the utilisation status is associated with accessing an array of memory storage cells. At S52, memory controller signals feedback indicative of the utilisation status to the initiator, and initiator receives the feedback at S53.

In the example of FIG. 5, the utilisation status indicates that the memory controller does not have capacity to process opportunistic memory access requests. As discussed above, this could be because the memory controller is not able to schedule further memory access requests, or the underlying memory storage cells are busy or not able to be accessed. As for FIG. 4, a single bit flag may be used to indicate whether the memory controller has capacity to process opportunistic memory access requests or not. In other examples, a multi-bit indicator may be used to provide a more granular indication of capacity.

In response to receiving the feedback at S53, the initiator suppresses generation of an opportunistic memory access request (S54). Thus, the initiator does not generate an opportunistic memory access request in response to determining that the feedback indicates that the memory controller does not have capacity to process opportunistic memory access requests. As a result, processing time at the initiator is preserved that would otherwise have been expended on generating an opportunistic memory access request that would not then be processed, and memory bandwidth is preserved as it is not being used to receive an opportunistic memory access request that would not then be processed.

In the examples of FIGS. 4 and 5, the feedback may be signalled using an indication separate from a read/write response. For example, the feedback may be signalled using a dedicated communication path. Accordingly, the feedback may be signalled by the memory controller at any time, and not necessarily in response to a read/write request. For example, the feedback could be signalled periodically, and may be set by configuration. In other examples, the feedback may be signalled in response to a read/write request and may be provided as part of a read/write response.

In the examples of FIGS. 4 and 5, the utilisation status may be indicative of a utilisation of a group of memory storage cells in the at least one array of memory storage cells. For example, the utilisation status may be indicative of a utilisation of a channel, a rank, a group of banks, , or a row of cells in the at least one array of memory storage cells. Further in some examples, the feedback may comprise information identifying a most or least utilised group (e.g. a rank, a group of banks, a bank, or a row of cells). In some examples, the information may rank a plurality of groups of memory cells based on utilisation. Alternatively, the information may identify only the most or least utilised memory cells.

Thus, the initiator may generate an opportunistic memory access request based on this information at S44, for example generating an opportunistic memory access targeting a location in a least utilised group of memory storage cells. The initiator may suppress generation of an opportunistic memory access request based on this information at S54, for example suppressing generation of an opportunistic memory access request that targets a location in the group of most utilised memory cells.

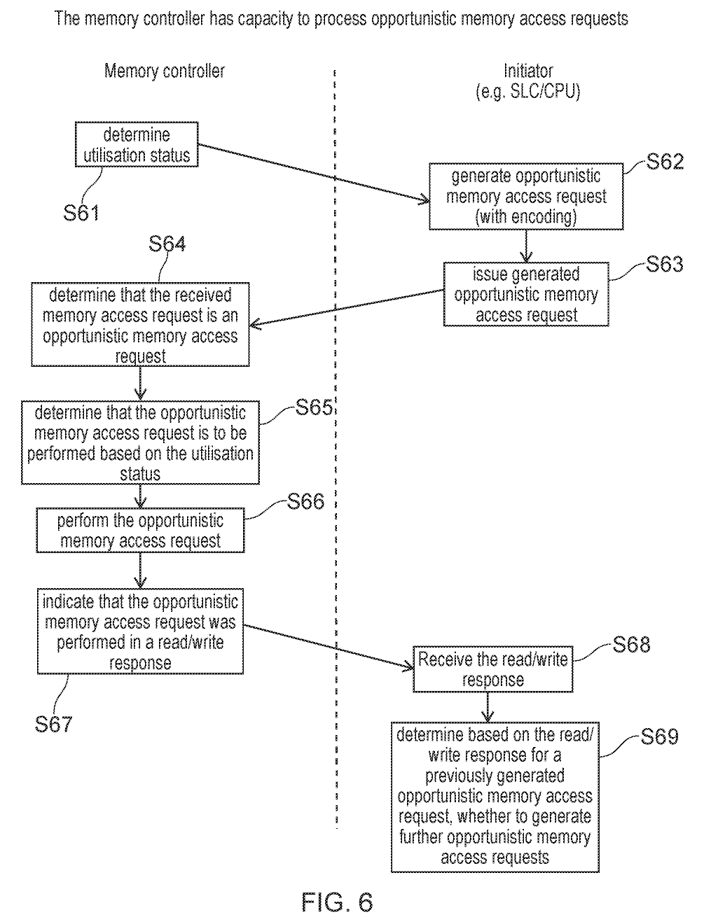

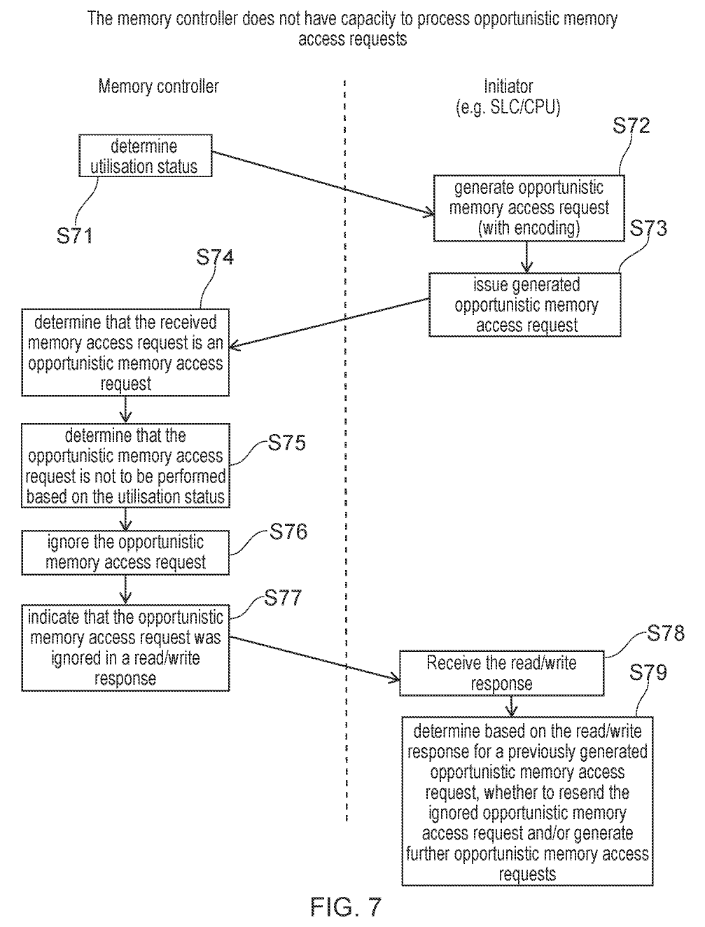

FIG. 6 shows a further example of signalling between a memory controller and initiator when the memory controller has capacity to process opportunistic memory access requests. In this example, an opportunistic memory access request is generated with an encoding, and feedback indicative of the utilisation status takes the form of a read/write response. It will be appreciated that steps and techniques described in FIGS. 4 to 7 may be combined variously. For example, feedback may be provided as part of a read/write response and/or the opportunistic memory access request may be provided with an encoding in FIGS. 4 and 5. Similarly, the utilisation status may be signalled in a similar manner in FIG. 6 and 7 as for FIGS. 4 and 5, for example after the memory controller determines the utilisation status at S61 and S71 of FIGS. 6 and 7. Further, discussion of similarly labelled steps across FIGS. 4 to 7 applies equally and is not repeated.

Like FIGS. 4 and 5, the memory controller determines a utilisation status (S61). It will be appreciated that S61 may be performed in a different order, for example after S62 or S63 or S64.

At S62, initiator generates an opportunistic memory access request. In the example of FIG. 6, the initiator generates an opportunistic memory access request that has an encoding indicating that the opportunistic memory access request may be ignored by the memory controller. As discussed herein, the opportunistic memory access request may be a prefetch request and/or a speculative cache writeback. Thus, the encoding may differentiate an opportunistic memory access request from a demand memory access request that is currently demanded by a memory request initiator (i.e. currently demanded by a load or store instruction). At S63, the initiator issues the generated opportunistic memory access request (having the encoding) to the memory controller.

Memory controller determines that the received memory access request is an opportunistic memory access request (S64) based on the encoding. For example, the memory controller may be configured to differentiate between opportunistic memory access requests (i.e. memory access requests that are not currently demanded by the initiator but are predicted to be required in the future – i.e. prefetch requests, speculative cache writeback requests) and demand memory access requests (i.e. memory access requests that are currently demanded by the initiator) based on the encoding.

The memory controller determines that the opportunistic memory access request is to be performed based on the utilisation status (S65). In the example of FIG. 6, the memory controller has capacity to process opportunistic memory access requests and so the utilisation status indicates this. Thus, at S66, the memory controller performs the opportunistic memory access request.

The memory controller then indicates that the opportunistic memory access request was performed in a read/write response issued to the initiator (S67). For example, the read/write response may be modified to include an indication that the opportunistic memory access request was performed. In examples, the read/write response may include a bit flag to indicate whether an opportunistic memory access request was performed. In this way, an existing signalling pathway may be used to provide feedback indicative of the utilisation status from the memory controller to the initiator. In the example of FIG. 6, feedback indicative of the utilisation status (i.e. whether the opportunistic memory access request was performed by the memory controller) is signalled to the initiator using the read/write response rather than an indication separate from a read/write response. However, it will be appreciated that both of these techniques may be combined. For example, the memory controller may signal feedback indicative of the utilisation status using an indication separate from a read/write response at a first time, and may signal feedback indicative of the utilisation status (i.e. whether the opportunistic memory access request was performed by the memory controller) at a second time.

At S68, the initiator receives the read/write response (i.e. the feedback) and determines based on the read/write response for the opportunistic memory access request (such as from S62) whether to generate further opportunistic memory access requests. In the example of FIG. 6, the read/write response indicates that the opportunistic memory access request was performed, and so the initiator may determine to generate further opportunistic memory access requests.

FIG. 7 shows a further example of signalling between a memory controller and initiator when the memory controller does not have capacity to process opportunistic memory access requests. Steps S71, S72, S73, and S74 correspond to steps S61, S62, S63, and S64, respectively, and thus discussion of these steps in FIG. 6 applies to these steps of FIG. 7 and is not repeated here.

In the example of FIG. 7, the memory controller does not have capacity to process opportunistic memory access requests and so the utilisation status determined at S71 indicates this. At S75, the memory controller determines that the opportunistic memory access request is not to be performed based on the utilisation status. Thus, at S76, the memory controller ignores the opportunistic memory access request (i.e. does not perform the opportunistic memory access request). In other words, the memory controller determines that it does not have capacity to process opportunistic memory access requests and so when one is received, the memory controller does not perform the memory access request.

At S77, the memory controller indicates that the opportunistic memory access request was ignored in a read/write response. For example, the read/write response may include an indication that the opportunistic memory access request was ignored. In some examples, the indication may be the absence of a confirmation indication that the opportunistic memory access request was performed.

At S78, the initiator receives the read/write response from the memory controller. At S79, the initiator determines, based on the read/write response for a previously generated opportunistic memory access request (such as that from S73), whether to resend the ignored opportunistic memory access request and/or generate a further opportunistic memory access request. In the example of FIG. 7, the memory controller ignores the opportunistic memory access request (S76) and indicates as such with the read/write response (S77). Thus, in this example, the initiator may determine to suppress generation of further opportunistic memory access requests for a predetermined time period following the read/write response, or until the initiator receives an indication from the memory controller (such as feedback) that the memory controller is able to process opportunistic memory access requests. In some examples, the initiator may determine to resend the ignored opportunistic memory access request at a later time.

In this way, there has been described a feedback signalling mechanism between a memory controller and a memory request initiator that enables the memory controller to signal feedback indicative of a determine utilisation status to the memory request initiator, and that enables the memory request initiator to take action in response and based on the signalled feedback.

Concepts described herein may be embodied in a system comprising at least one packaged chip. Either or both of the apparatuses (such as apparatus 20 of FIG. 2a and apparatus 28 of FIG. 2b) described earlier are implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

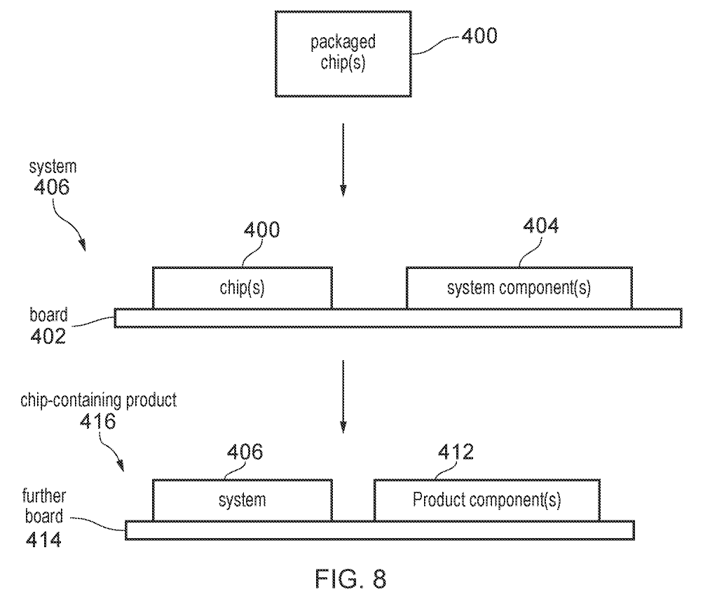

As shown in FIG. 8, one or more packaged chips 400, with either or both of the apparatuses (such as apparatus 20 of FIG. 2a or apparatus 28 of FIG. 2b) described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus (such as apparatus 20 of FIG. 2a or apparatus 28 of FIG. 2b) described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus comprising:

memory control circuitry to control access to at least one array of memory storage cells and to schedule received memory access requests targeting locations in the at least one array of memory storage cells;

utilisation status determining circuitry to determine a utilisation status associated with accessing the array of memory storage cells; and

feedback signalling circuitry to signal to a source of the received memory access requests feedback indicative of the determined utilisation status;

in which the utilisation status is indicative of a utilisation of a group of memory storage cells in the at least one array of memory storage cells.

2. The apparatus of clause 1, in which the at least one array of memory storage cells comprises DRAM storage.

3. The apparatus of any preceding clause, in which the feedback is indicative of whether the memory control circuitry has capacity to process opportunistic memory access requests, the opportunistic memory access requests being memory access requests not currently demanded by a memory access request initiator but predicted to be required in future.

4. The apparatus of clause 3, in which the opportunistic memory access requests comprise one or more of:

speculative cache writebacks; and/or prefetch requests.

5. The apparatus of any preceding clause, in which the utilisation status is indicative of a utilisation of the memory control circuitry.

6. The apparatus of any preceding clause, in which the utilisation status is indicative of an ability of the memory control circuitry to schedule received memory access requests.

7. The apparatus of any preceding clause, in which the group of memory storage cells in the at least one array of memory storage cells corresponds to one of: a channel; a rank; a group of banks; a bank; and a row of cells in the at least one array of memory storage cells.

8. The apparatus of any preceding clause, in which the feedback comprises information identifying a most or least utilised group of memory storage cells.

9. The apparatus of any preceding clause, in which the memory control circuitry is configured to: determine that a received memory access request is an opportunistic memory access request based on an encoding associated with the received memory access request indicating that the received memory access request may be ignored, and determine, based on the utilisation status, whether the opportunistic memory access request is to be ignored.

10. The apparatus of clause 9, in which the feedback signalling circuity is configured to signal the feedback as part of a read/write response issued in response to receiving the opportunistic memory access request.

11. The apparatus of any of clauses 9 and 10, in which the feedback indicates that the opportunistic memory access request has been ignored.

12. The apparatus of any of clauses 1 to 9, in which the feedback signalling circuitry is configured to signal the feedback using an indication separate from a read/write response.

13. An apparatus comprising:

feedback receiving circuitry to receive feedback indicative of a utilisation status associated with accessing an array of memory storage cells; and speculative cache writeback circuitry to determine whether to generate a speculative cache writeback request based on the received feedback indicative of the utilisation status associated with accessing the array of memory storage cells.

14. The apparatus of clause 13, in which the speculative cache writeback circuitry is configured to determine that the speculative cache writeback request is not to be generated based on determining that the feedback indicates that memory control circuitry controlling access to the array of memory storage cells does not have capacity to process speculative cache writeback requests.

15. The apparatus of any of clauses 13 or 14, in which the speculative cache writeback circuitry is configured to determine that the speculative cache writeback request is to be generated based on determining that the feedback indicates that memory control circuitry controlling access to the array of memory storage cells has capacity to process speculative cache writeback requests.

16. The apparatus of any of clauses 13 to 15, in which the feedback comprises information indicative of a utilisation of a group of memory storage cells in the array of memory storage cells.

17. The apparatus of any of clauses 13 to 16, in which the feedback comprises information identifying a least or most utilised group of memory storage cells.

18. The apparatus of any of clauses 13 to 17, in which the speculative cache writeback circuitry is configured to generate a speculative cache writeback request targeting a location in the array of memory storage cells based on the feedback.

19. The apparatus of any of clauses 13 to 18, in which the speculative cache writeback request has an encoding indicating that the speculative cache writeback request may be ignored by memory control circuitry controlling access to the array of memory storage cells.

20. The apparatus of any of clauses 13 to 19, in which the feedback receiving circuity is configured to receive the feedback as part of a read/write response received in response to a given speculative cache writeback request issued by the speculative cache writeback circuitry to memory control circuitry.

21. The apparatus of any of clauses 13 to 20, in which the feedback receiving circuitry is configured to receive the feedback via an indication separate from a read/write response.

22. The apparatus of any of clauses 13 to 21, in which the array of memory storage cells comprises DRAM storage.

23. The apparatus of any of clauses 13 to 22, in which the feedback comprises information identifying a least utilised group of memory cells, and the speculative cache writeback circuitry is configured to generate a speculative cache writeback request targeting a location in the array of memory storage cells corresponding to the least utilised group of memory cells.

24. The apparatus of any of clauses 13 to 23, in which the feedback comprises information identifying a most utilised group of memory cells, and the speculative cache writeback circuitry is configured to suppress generation of a speculative cache writeback request targeting a location in the array of memory storage cells corresponding to the most utilised group of memory cells.

25. An apparatus comprising:

feedback receiving circuitry to receive feedback indicative of a utilisation status associated with accessing an array of memory storage cells; and opportunistic memory access request generation circuitry to determine whether to generate an opportunistic memory access request based on the received feedback indicative of the utilisation status associated with accessing the array of memory storage cells, the opportunistic memory access request being a memory access request not currently demanded by a memory access request initiator but predicted to be required in future.

26. The apparatus of clause 25, in which the opportunistic memory access request comprises one or more of:

a speculative cache writeback; and/or a prefetch request.

27. The apparatus of any of clauses 25 or 26, in which the array of memory storage cells comprises DRAM storage.

28. The apparatus of any clauses 25 to 27, in which the opportunistic memory access request generation circuitry is configured to determine that the opportunistic memory access request is not to be generated based on determining that the feedback indicates that memory control circuitry controlling access to the array of memory storage cells does not have capacity to process opportunistic memory access requests.

29. The apparatus of any of clauses 25 to 28, in which the opportunistic memory access request generation circuitry is configured to determine that the opportunistic memory access request is to be generated based on determining that the feedback indicates that memory control circuitry controlling access to the array of memory storage cells has capacity to process opportunistic memory access requests.

30. The apparatus of any of clauses 25 to 29, in which the feedback comprises information indicative of a utilisation of a group of memory storage cells in the array of memory storage cells.

31. The apparatus of clause 30, in which the feedback comprises information identifying a least or most utilised group of memory storage cells.

32. The apparatus of any of clauses 30 or 31, in which the opportunistic memory access request generation circuitry is configured to generate an opportunistic memory access request targeting a location in the array of memory storage cells based on the feedback.

33. The apparatus of any of clauses 25 to 32, in which the feedback comprises information identifying a least utilised group of memory cells, and the opportunistic memory access request generation circuitry is configured to generate an opportunistic memory access request targeting a location in the array of memory storage cells corresponding to the least utilised group of memory cells.

34. The apparatus of any of clauses 25 to 33, in which the feedback comprises information identifying a most utilised group of memory cells, and the opportunistic memory access request generation circuitry is configured to suppress generation of an opportunistic memory access request targeting a location in the array of memory storage cells corresponding to the most utilised group of memory cells.

35. The apparatus of any of clauses 25 to 34, in which the opportunistic memory access request has an encoding indicating that the opportunistic memory access request may be ignored by memory control circuitry controlling access to the array of memory storage cells.

36. The apparatus of any of clauses 25 to 35, in which the feedback receiving circuity is configured to receive the feedback as part of a read/write response received in response to a given opportunistic memory access request issued by the opportunistic memory access request generation circuitry to memory control circuitry.

37. The apparatus of any of clauses 25 to 36, in which the feedback receiving circuitry is configured to receive the feedback via an indication separate from a read/write response.

38. The apparatus of any of clauses 25 to 37, in which the opportunistic memory access request comprises a prefetch request, and the opportunistic memory access request generation circuitry is prefetch control circuitry to control issuing of the prefetch request to memory control circuitry to prefetch data from the array of memory storage cells.

39. The apparatus of any of clauses 25 to 39, which the opportunistic memory access request comprises a speculative cache writeback request, and the opportunistic memory access request generation circuitry is system cache control circuitry to control issuing of the speculative cache writeback request to the memory control circuitry.

40. A non-transitory computer-readable medium storing computer-readable code for fabrication of the apparatus of any preceding clause.

41. A system comprising the apparatus of any of clauses 1 to 12 and the apparatus of any of clauses 13 to 39.

42. A system comprising:

the apparatus of any of clauses 1 to 39, implemented in at least one packaged chip;

at least one system component; and a board, wherein the at least one packaged chip and the at least one system component are assembled on the board.

43. A chip-containing product comprising the system of clause 42, wherein the system is assembled on a further board with at least one other product component.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
memory control circuitry to control access to at least one array of memory storage cells and to schedule received memory access requests targeting locations in the at least one array of memory storage cells;
utilisation status determining circuitry to determine a utilisation status associated with accessing the array of memory storage cells; and
feedback signalling circuitry to signal to a source of the received memory access requests feedback indicative of the determined utilisation status;
in which the utilisation status is indicative of a utilisation of a group of memory storage cells in the at least one array of memory storage cells.

2. The apparatus of claim 1, in which the at least one array of memory storage cells comprises DRAM storage.

3. The apparatus of claim 1, in which the feedback is indicative of whether the memory control circuitry has capacity to process opportunistic memory access requests, the opportunistic memory access requests being memory access requests not currently demanded by a memory access request initiator but predicted to be required in future.

4. The apparatus of claim 1, in which the group of memory storage cells in the at least one array of memory storage cells corresponds to one of: a channel; a rank; a group of banks; a bank; and a row of cells in the at least one array of memory storage cells.

5. The apparatus of claim 1, in which the feedback comprises information identifying a most or least utilised group of memory storage cells.

6. The apparatus of claim 1, in which the memory control circuitry is configured to: determine that a received memory access request is an opportunistic memory access request based on an encoding associated with the received memory access request indicating that the received memory access request may be ignored, and determine, based on the utilisation status, whether the opportunistic memory access request is to be ignored.

7. The apparatus of claim 6, in which the feedback signalling circuity is configured to signal the feedback as part of a read/write response issued in response to receiving the opportunistic memory access request.

8. The apparatus of claim 1, in which the feedback signalling circuitry is configured to signal the feedback using an indication separate from a read/write response.

9. An apparatus comprising:
feedback receiving circuitry to receive feedback indicative of a utilisation status associated with accessing an array of memory storage cells; and
speculative cache writeback circuitry to determine whether to generate a speculative cache writeback request based on the received feedback indicative of the utilisation status associated with accessing the array of memory storage cells.

10. The apparatus of claim 9, in which the speculative cache writeback circuitry is configured to determine that the speculative cache writeback request is not to be generated based on determining that the feedback indicates that memory control circuitry controlling access to the array of memory storage cells does not have capacity to process speculative cache writeback requests.

11. The apparatus of claim 9, in which the speculative cache writeback circuitry is configured to determine that the speculative cache writeback request is to be generated based on determining that the feedback indicates that memory control circuitry controlling access to the array of memory storage cells has capacity to process speculative cache writeback requests.

12. The apparatus of claim 9, in which the feedback comprises information indicative of a utilisation of a group of memory storage cells in the array of memory storage cells.

13. The apparatus of claim 9, in which the feedback comprises information identifying a least or most utilised group of memory storage cells.

14. The apparatus of claim 9, in which the speculative cache writeback circuitry is configured to generate a speculative cache writeback request targeting a location in the array of memory storage cells based on the feedback.

15. The apparatus of claim 9, in which the speculative cache writeback request has an encoding indicating that the speculative cache writeback request may be ignored by memory control circuitry controlling access to the array of memory storage cells.

16. The apparatus of claim 9, in which the feedback receiving circuity is configured to receive the feedback as part of a read/write response received in response to a given speculative cache writeback request issued by the speculative cache writeback circuitry to memory control circuitry.

17. The apparatus of claim 9, in which the feedback receiving circuitry is configured to receive the feedback via an indication separate from a read/write response.

18. A non-transitory computer-readable medium storing computer-readable code for fabrication of the apparatus of claim 1.

19. A system comprising:
the apparatus of claim 1, implemented in at least one packaged chip;
at least one system component; and
a board,
wherein the at least one packaged chip and the at least one system component are assembled on the board.

20. A chip-containing product comprising the system of claim 19, wherein the system is assembled on a further board with at least one other product component.
